(19) United States
(12) Patent Application Publication
(10) Pub. No.: US 2010/0306109 A1
(43) Pub. Date: Dec. 2, 2010

(54) Method, system, server and computer program for services

(75) Inventor: Ilkka Keisala, Espoo (FI)

Correspondence Address: COHEN, PONTANI, LIEBERMAN & PAVANE LLP, 551 FIFTH AVENUE, SUITE 1210, NEW YORK, NY, 10176, US

(73) Assignee: TeliaSonera AB, Stockholm (SE)

(21) Appl. No.: 12/800,837

(22) Filed: May 24, 2010

(30) Foreign Application Priority Data
May 28, 2009 (EP) 09161394.3

(51) Int. Cl. G06Q 30/00; G06Q 40/00; G06F 21/00; G06F 15/16

(52) U.S. Cl. 705/44; 726/4; 709/238

(57) ABSTRACT

The invention is related to a system, comprising: an authentication server configured to carry out authentication based on a user identity module for defining a user identification; an authorization server configured to check information on user's entitlement to services based on the user identification; a gateway server configured to establish a secured connection, receive a payment message from a service server, forward the payment message to the user, receive a message comprising user's acceptance of a payment transaction, convey the user's acceptance of the payment to the service server, and add the user identification to the secured connection or the message comprising the user's acceptance of a payment transaction; and a service server configured to secure a payment transaction by using the user identification.

### BACKGROUND OF THE INVENTION

1. Field of the Invention

The invention relates to a method, system, gateway server and computer program for services.

2. Description of the Related Art

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Nowadays a plenty of services are available via a web, such as the Internet. Technical development has extended possibilities to purchase services and goods despite of their location. On the Internet, the supply of web shops is large in quantity as well as in scope.

### SUMMARY OF THE INVENTION

According to an aspect of the present invention, there is provided a method comprising: carrying out authentication based on a user identity module for defining a user identification by an authentication server and a home location register; checking information on user's entitlement to services based on the user identification by an authorization server; if the user is entitled to secured connection services, establishing a secured connection session between a user device and a gateway server by the gateway server; receiving a payment message from a service server, forwarding the payment message to the user, and receiving a message comprising user's acceptance of a payment transaction by the gateway server; adding the user identification to the secured connection or the message comprising the user's acceptance of a payment transaction, and conveying the user's acceptance of the payment transaction to the service server by the gateway server; and securing the payment transaction by using the user identification by the service server or the gateway server.

According to another aspect of the present invention, there is provided a system, comprising: an authentication server configured to carry out authentication based on a user identity module for defining a user identification; an authorization server configured to check information on user's entitlement to services based on the user identification; a gateway server configured to establish a secured connection, receive a payment message from a service server, forward the payment message to the user, receive a message comprising user's acceptance of a payment transaction, convey the user's acceptance of the payment to the service server, and add the user identification to the secured connection or the message comprising the user's acceptance of a payment transaction; and a service server configured to secure a payment transaction by using the user identification.

According to another aspect of the present invention, there is provided an apparatus, comprising a processing unit and a memory including a computer program code, the memory and the computer program code configured to, with the processor, cause the apparatus at least to: establish a secured connection, receive a payment message from a service server, forward the payment message to a user, receive a message comprising user's acceptance of a payment transaction, add a predetermined user identification to the secured connection or the message comprising the user's acceptance of a payment transaction, and convey the user's acceptance of the payment transaction to the service server.

According to another aspect of the present invention, there is provided a computer program product, embodied on a computer-readable medium configured to control a processor to perform a method, the method comprising: carrying out authentication based on a user identity module for defining a user identification by an authentication server and a home location register, checking information on user's entitlement to services based on the user identification by an authorization server, if the user is entitled to secured connection services, establishing a secured connection session between a user device and a gateway server by the gateway server, receiving a payment message from a service server, forwarding the payment message to the user, and receiving a message comprising user's acceptance of a payment transaction by the gateway server, adding the user identification to the secured connection or the message comprising the user's acceptance of a payment transaction, and conveying the user's acceptance of the payment transaction to the service server by the gateway server, and securing the payment transaction by using the user identification by the service server or the gateway server.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Embodiments of the present invention are described below, by way of example only, with reference to the accompanying drawings, in which

FIG. 1 illustrates an example of a communication system;

FIG. 2 is a flow chart; and

FIG. 3 illustrates an example of a gateway server.

### DETAILED DESCRIPTION OF THE PRESENTLY PREFERRED EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any server, node or host, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of a system architecture whereto the embodiments may be applied, an architecture based on a system able to provide a secured connection, such as a Virtual Private Network (VPN) tunnel for packet transmission, such as an Internet Key Exchange protocol version 2 (IKEv2) Internet Protocol Security (IPSec) VPN tunnel.

Many different radio protocols to be used in communications systems for establishing a wireless connection exist. Some examples of different communication systems include Global System for Mobile Communications (GSM), the Universal Mobile Telecommunications System (UMTS) radio access network (UTRAN or E-UTRAN), Long Term Evolution (LTE, the same as E-UTRA), Wireless Local Area Network (WLAN), Worldwide Interoperability for Microwave Access (WiMAX), Bluetooth®, Personal Communications Services (PCS) and systems using ultra-wideband (UWB) technology.

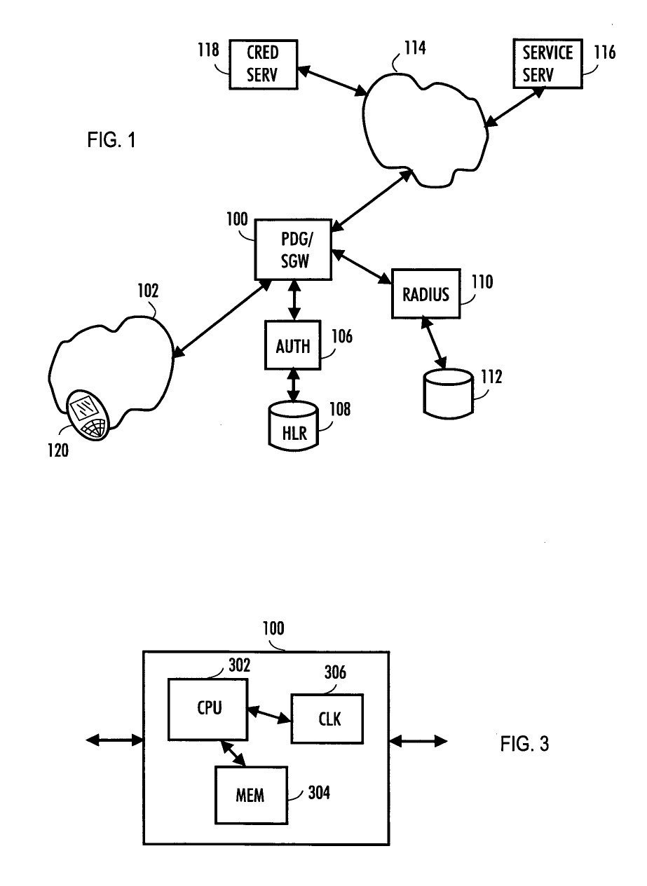

FIG. 1 is a simplified system architecture only showing some elements and functional entities, all being logical units whose implementation may differ from what is shown. The connections shown in FIG. 1 depict logical connections; the actual physical connections may be different. It is apparent to a person skilled in the art that the systems also comprise other functions and structures.

FIG. 1 shows a part of an example of architecture for communication over a web, such as the Internet. The radio system providing connections over a radio path is not described, since radio protocols used are not relevant regarding embodiments of the invention.

Embodiments are not, however, restricted to the system given as an example but a person skilled in the art may apply the solution to other communication systems provided with the necessary properties.

The system is first explained only shortly.

A communications system operator maintains a gateway server 100, such as a Packet Data Gateway (PDG) or a signalling gateway (SGW). The Packet Data Gateway acts as gateway of a secured connection, such as a Virtual Private Network (VPN) gateway. The Virtual Private Network (VPN) is a computer-based network in which selected connections between nodes are carried out by virtual circuits which thus perform a part of a larger network, such as the Internet. The link-layer protocols of the virtual network are usually tunnelled via the larger network. VPNs may be used to separate traffic of different user communities over an underlying network.

The operator also maintains an authentication server, such as an Extensible Authentication Protocol Subscriber Identity Module (EAP-SIM) server or Authentication and Key Agreement (EAP-AKA) 106. EAP is a universal authentication framework mostly used in wireless networks and Point-to-Point connections. EAP-SIM is a protocol mechanism designed for authentication and session key distribution using a Subscriber Identity Module (SIM), and EAP-AKA is a mechanism for authentication and session key distribution using for example a Universal Subscriber Identity Module (USIM). A Universal Integrated Circuit Card (UICC) may be an implementation of SIM or USIM. An UICC is a smart card used in mobile terminals in GSM and UMTS networks. The UICC ensures the integrity and security of personal data.

In a GSM network, the UICC contains a SIM application and in a UMTS network it contains a USIM application. A UICC may contain several applications, making it possible for the same smart card to give access to both GSM and UMTS networks.

A home Location Register (HLR) 108 may also be available. HLR is a database containing information on subscribers. Home Location Register typically stores subscriber information permanently.

An authorization server 110 may be a Remote Authentication Dial In User Service (RADIUS) server or a Diameter which is a networking protocol for AAA (Authentication, Authorization and Accounting). A Diameter is a successor to RADIUS. Typically, the authorization server is a remote authentication dial-in user service server.

RADIUS is a networking protocol using access servers to provide centralized management of access to large networks. RADIUS is commonly used in connection with the Internet or internal networks employing a variety of networking technologies, including modems and Virtual Private Networks.

A user may use user device 120 which is operationally coupled to the Internet (or corresponding network) 102 via a Wireless Local Area Network (WLAN) which is also known in a commercial name Wi-Fi when used for the Internet. Other corresponding networks include Broadband 450 and Worldwide Interoperability for Microwave Access (WiMAX) or similar access types enabling connection to the Internet. The Internet is an example of an unsecured network.

The user device may refer to portable computing devices. Such computing devices include wireless mobile communication devices including, but not limited to, the following types of devices: a mobile phone, smartphone, personal digital assistant (PDA), handset, multimedia device, game console, laptop (a notebook), etc.

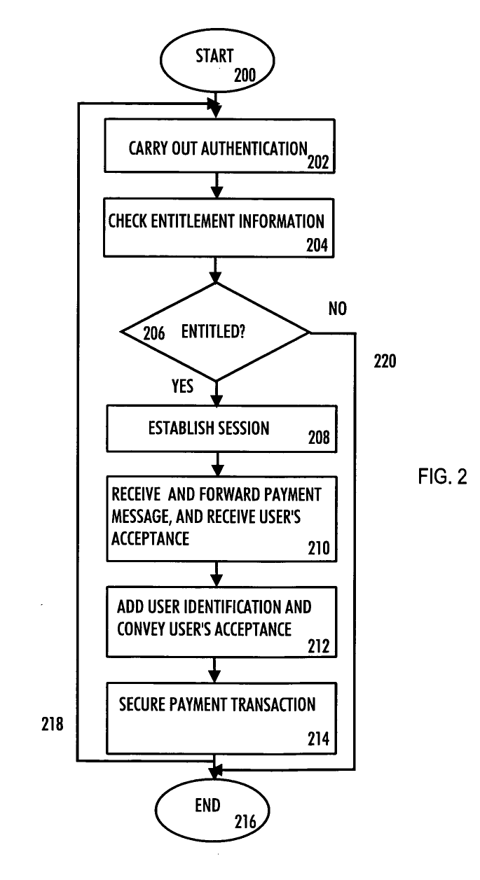

An embodiment of the invention will now be explained in further detail by means of FIG. 1 and FIG. 2. FIG. 2 is a flow chart depicting an embodiment of a method according to the invention. The method starts in block 200.

In block 202, authentication is carried out based on a user identity module for defining user identification by an authentication server and a home location register. This authentication may also be called subscriber identity module (SIM) authentication. Authentication is a process to verify a person's identity by reading it from a SIM card and to carry out the user's subscription on an operator's network. This authentication may be a typical mobile subscription authentication enabling also a secure connection between the user and the operator. A user identity module includes authentication information, such as user identification. The user identification may be stored on a subscriber identity module. Many kinds of user identity modules exist. A subscriber identity module (SIM) is one example. A SIM is typically a part of a removable smart card such as an Integrated Circuit Card. SIM cards are used in mobile devices, such as mobile computers and mobile phones. SIM cards store information for identification of a subscriber, such as an International Mobile Subscriber Identity (IMSI), Authentication Key (Ki) and Local Area Identity (LAI). The equivalent of a SIM in the UMTS is called a Universal Subscriber Identity Module (USIM), and in CDMA-based system a Removable User Identity Module (RUIM). In this application, a SIM or a subscriber identity module means all modules including identity information not depending on the communication system.

An authentication server may be an Extensible Authentication Protocol Subscriber Identity Module (EAP-SIM) server (106 in FIG. 1).

In block 204, information on user's entitlement to services is checked based on the user identification by an authorization server (In FIG. 1, 110). The authorization server is coupled to a database including data about services available to certain users. The entitlement information (or authorization information) may be stored also on a credit server which may be a web service maintained by a bank or a credit company and/or in a database related to the authorization server.

This process may also be called authorization. Authorization is typically carried out for ensuring that access to resources is allowed only to permitted subscribers. Resources may be files or data, computer programs, computer devices and functionality provided by computer applications. Authentication and authorisation together are sometimes called access control.

An authorization server may be a remote authentication dial-in user service (RADIUS) server (110 in FIG. 1). Authorization information is typically stored in a database (112 in FIG. 1).

A virtual private network session (VPN) is a computer-based network in which selected connections between nodes are carried out by virtual circuits which thus perform a part of a larger network, such as the Internet. A VPN connection is often called a VPN tunnel.

If the user is entitled to secured connection services, such as virtual private network services (block 206), a secured connection is established by a gateway server (block 208). The gateway server may be a Packet Data Gateway (PDG) or a signalling gateway (SGW). The user may thus be in connection with a service using this VPN tunnel from terminal to PDG/SGW and further to the Internet.

In block 210, a payment message is received from a service server (FIG. 1, 116), forwarded to the user, and a message comprising user's acceptance of a payment transaction is received by the gateway server (FIG. 1, 100).

The service server may provide a user-interactive network sales system for implementing a marketplace for goods and/or services over computer networks such as the Internet. This kind of a market place is called a web shop. This kind of a service server may be called a commercial service server.

In an embodiment, a service server sends an accepted payment message to a credit server for a security check.

The service server may construct a payment order, send it to the user, and after receiving the credit card details from a user, send the details for a security check of the purchase to another resource before accepting the payment transaction. Also a gateway server, such as an SGW, typically knows based on the service entitlement of the user that to certain traffic towards the services (typically commercial) the user identification is added (typically MSISDN). After this there are two possible ways to make the security check: first, a credit server has a connection to an SGW, and it sends the connection details (e.g. MSISDN and message identification) to the SGW to verify that these details belong together, or second, a commercial service sends credit card details together with a user identification (typically MSISDN) to the credit server, and the credit server has been informed that if this credit card is used for a payment, certain user identification (MSISDN) must be attached to the payment message. Otherwise it does not accept the payment.

In block 212, the user identification is added to the secured connection or the message comprising the user's acceptance of a payment transaction, and the user's acceptance of the payment transaction is conveyed to the service server by the gateway server.

Typically, the gateway server adds a user identification, such as a Mobile Subscriber International ISDN (Integrated Services Digital Network) Number (MSISDN) to the secured user connection. The gateway server may inform the service server about the user identification. An MSISDN consists of a country code, national destination code and subscriber number.

The gateway server usually has information on the user messages which the identification is going to be added to. In an embodiment, the user identification is added to a payment message from a user device to a service server. The gateway server receives the information on these users and services from a RADIUS. In an embodiment, a user has a UICC or Universal Serial Bus (USB) device such as a memory stick into which a SIM-card (or another user identity module) and a payment functionality such as a credit card have been integrated. The USB-device typically also includes user interface application software. When a user connects the USB-device to his user device, the application is opened for a user-interactive session. Typically, a client computer program comprising program instructions for running the service is included in the UICC or USB-SIM combination.

In block 214, the payment transaction is secured by using the user identification by the service server (FIG. 1, 116). The secured connection used may be a virtual private network session (VPN). Typically, a VPN session is established between a user device and the gateway server. The service server has a connection to the user device 120 typically using a Hypertex Transfer Protocol Secure (HTTPS) protocol.

Typically, an identification of a payment means, such as a credit card number, is requested from the user or retrieved from a SIM card of the user device. A UICC or combined USB-SIM may include a credit card number as a default, but the user may also select the number of the credit card he or she enters, for instance if the user has several credit cards. The default credit card number may also be known by a server being responsible for checking credit card information, such as a credit server (see FIG. 1, 118) which may be a web service maintained by a bank or credit company. The credit server may verify that the user identification (such as an MSISDN) related to a secured connection (such as a VPN session (such as IKEv2/IPSec)) is related to the credit card details and the user identification stored in the credit server.

In an embodiment, a gateway server adds the user identification such as an MSISDN of the user to an HTTPS connection request which is secured by the server at a web-shop event, such as a payment transaction. Because the SGW adds an MSISDN to the payment message, this procedure provides a possibility to prevent misuse of the MSISDN. The gateway server retrieves the MSISDN of the user after access rights of user have been authorised by a RADIUS server.

In an embodiment, the service server may also validate an accepted payment message and forward it to a credit server.

In yet another embodiment, securing may be carried out as follows: a gateway server verifies for a credit server that a user identification is related to the secured connection in question, and/or the gateway server adds the user identification to the secured connection or a message comprising the user's acceptance of a payment transaction, and conveys the message to a credit server for securing a payment transaction.

The embodiment ends in block 216. The embodiment is repeatable. One option for repetition is shown by arrow 218.

If the user is not entitled to the secured connection, such as the VPN service, the embodiment is ended (arrow 220).

In an embodiment, in the authentication to a home location register (FIG. 1, 108) via an authentication server (FIG. 1, 106), subscriber's MSISDN is verified. After that the user's access right to the operator's services is verified typically by a RADIUS server (FIG. 1, 110). Authorisation to services such as commercial services is therefore checked. In this authorization phase, a UICC or USB-SIM combination of a user device may be used. Both the authentication phase and the authorisation to the operator's service set may be carried out separately or as one event.

The RADIUS server may inform the gateway server of the successful SIM/USIM authentication, MSISDN of the user device, services related to the MSISDN and then the gateway server may establish a VPN connection to the user device.

It should be noticed that the server operations illustrate a procedure that may be implemented in one or more physical or logical entities. The signaling messages are only exemplary and may even comprise several separate messages for transmitting the same information. In addition, the messages may also contain other information.

The steps/points, signaling messages and related functions described above in FIG. 2 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point. The server operations illustrate a procedure that may be implemented in one or more physical or logical entities. The signaling messages are only exemplary and may even comprise several separate messages for transmitting the same information. In addition, the messages may also contain other information.

Next, a system according to an embodiment is explained in further detail. The system shown in FIG. 1 is an example using as a secured connection a virtual private network (VPN session). Other secured connections are also applicable.

The system is shown in FIG. 1, and discussed in relation to FIGS. 1 and 2. The system's functionality and system elements are described in the light of enabling a use of a service, such as a web shop. In FIG. 1, the service is provided by a web shop 116 to which the user has an HTTPS connection via the Internet (or corresponding network) 114. Typically also financial services are provided by a credit server 118 which may be a web service maintained by a bank or a credit company. The credit server typically maintains information about which users have a UICC or USB-SIM combination enabling the use of a service wherein a payment transaction is secured by a service server using the user identification in connection with the virtual private network session between the gateway server and user device. Further, the gateway server is operationally coupled (the term “operationally coupled” may mean a wireless connection or a wired connection between two modules, units or apparatuses, etc. It may be internal or external. The connection may be straight or via one or more intermediate modules, units or apparatuses, etc.) to the service server by an HTTPS connection. Additionally, the credit server may also maintain information on users' entitlement to services based on the information on the existence of the UICC or USB-SIM combination.

A user 120 establishes a connection to the Internet via an unsecured network 102 such as the Wireless Local Area Network (WLAN) which is also known by a commercial name Wi-Fi when used for the Internet. Other corresponding networks include Broadband 450 and Worldwide Interoperability for Microwave Access (WiMAX) or a fixed line connection.

The system includes an authentication server 106, which in this example is an EAP-SIM server, configured to carry out authentication based on a user identity module for defining a user identification.

An authorization server 110, which in this example is a RADIUS, is configured to check information on user's entitlement to services based on the user identification. Typically, a user is only provided with services he or she has access to.

A gateway server 100, which in this example is a Packet Data Gateway (PDG) or a signalling gateway (SGW), is configured to establish a secured connection, such as a virtual private network session, receive a payment message from a service server, forward the payment message to a user, receive a message comprising the user's acceptance of a payment transaction, add the user identification to the secured connection or the message comprising the user's acceptance of a payment transaction, and convey the user's acceptance of the payment to the service server.

The gateway server may secure and/or add a user identification to an HTTPS connection request relating to its dedicated virtual private network session, and transfer the transaction to the server for further processing.

In an embodiment, a user connects to a service server for transacting business. Then, for verifying the business transaction, the service server sends a transaction message to be verified by the user. The user verifies the transaction message by adding a credit card number to it and after that sends the message back to the service server. A gateway server verifies for a credit server that the user identification is related to the secured connection in question by the gateway server.

The gateway server may verify for a credit server that the user identification is related to the secured connection in question by the gateway server, or add the user identification to the secured connection or the message comprising the user's acceptance of a payment transaction, and convey the message by the gateway server to a credit server for securing a payment transaction.

Typically, the gateway server verifies the existence of a subscriber identity module including a payment functionality and adds a user identity, such as an MSISDN to a response message and forwards it to the service server which forwards it to a credit server or the gateway server sends the message directly to the credit server which then secures that the credit card number and the MSISDN belong together. This may be based on the service set the user has retrieved by the Radius from the database 112.

The gateway server secures the message with the user identification relating to a VPN session (such as IKEv2/IPSec) in question.

Another option is that the gateway server adds the user identification to a response message of the secured connection which is intended to a credit server for securing a payment transaction by the gateway server. In this case the credit server asks the gateway server whether the MSISDN is related to the secured connection or a certain message. If it is related, the credit card server accepts the payment transaction.

In a further embodiment, a gateway server may also add the MSISDN of the user to a Hypertex Transfer Protocol Secure (HTTPS) request which is used to secure the web-shop event by a service server. This procedure provides a possibility to prevent misuse of a MSISDN.

In yet a further embodiment, the existence of a subscriber identity module including a payment functionality may also be determined by the gateway server or a credit server, and the user may be requested for a credit card number and user identification.

It should be understood that the system may also provide a router configured to route service requests to each service server by a proxy server.

FIG. 3 is a block diagram of an apparatus according to an embodiment of the invention. Although the apparatus has been depicted as one entity, different modules may be implemented in one or more physical or logical entities. The apparatus of this example is a network element which may be a host or a node acting as a gateway server. The apparatus may also be a server component. It is also obvious that the apparatus may also include parts not disclosed herein.

The gateway server 100 may be implemented as an electronic digital computer, which may comprise a working memory (RAM) 304, a central processing unit (CPU) 302, and a system clock 306. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions. The gateway server is operationally coupled to a network it serves.

A gateway server may comprise means (302) for establishing a secured connection, means (302, 304) for receiving a payment message from a service server, means (302, 304) for forwarding the payment message to the user, means (302, 304) for receiving a message comprising user's acceptance of a payment transaction, means (302, 304) for adding a predetermined user identification to the secured connection or the message comprising the user's acceptance of a payment transaction, and means (302, 304) for conveying the user's acceptance of the payment transaction to the service server. The user identification (typically MSISDN) may be added to the HTTPS header or payment transaction header.

The functionality of the gateway server is further explained in connection with FIG. 2.

An embodiment provides a computer program embodied on a distribution medium, comprising program instructions which, when loaded into an electronic apparatus, constitute the functionality of a gateway server described above.

The computer program may be in source code form, object code form, or in some intermediate form, and it may be stored in some sort of carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A method comprising:
carrying out authentication based on a user identity module for defining a user identification by an authentication server and a home location register;
checking information on user's entitlement to services based on the user identification by an authorization server;
if the user is entitled to secured connection services,
establishing a secured connection session between a user device and a gateway server by the gateway server;
receiving a payment message from a service server, forwarding the payment message to the user, and receiving a message comprising user's acceptance of a payment transaction by the gateway server;
adding the user identification to the secured connection or the message comprising the user's acceptance of a payment transaction, and conveying the user's acceptance of the payment transaction to the service server by the gateway server; and
securing the payment transaction by using the user identification by the service server or the gateway server.

2. The method of claim 1, wherein the authentication server is an extensible authentication protocol subscriber identity module (EAP-SIM) server, the gateway server is a packet data gateway (PDG) or a signaling gateway (SGW) and the authorization server is a remote authentication dial-in user service server.

3. The method of claim 1, wherein the user identification is stored on a subscriber identity module and the user is operationally coupled to an unsecured network via the secured connection session.

4. The method of claim 1, wherein the user uses a universal serial bus device in which a subscriber identity module and a payment functionality have been integrated.

5. The method of claim 1, further comprising:
determining the existence of a subscriber identity module including a payment functionality by the gateway server or a credit server;
requesting the user for a credit card number and user identification.

6. The method of claim 1, further comprising in securing: verifying for a credit server that the user identification is related to the secured connection in question by the gateway server, and adding the user identification to the secured connection or to the message comprising the user's acceptance of a payment transaction, and conveying the message by the gateway server to a credit server for securing a payment transaction.

7. The method of claim 1, further comprising in securing: verifying for a credit server that the user identification is related to the secured connection in question by the gateway server, or adding the user identification to the secured connection or to the message comprising the user's acceptance of a payment transaction, and conveying the message by the gateway server to a credit server for securing a payment transaction.

8. The method of claim 1, wherein the service server is further configured to forward the accepted payment message to a credit server.

9. A system, comprising:
an authentication server configured to carry out authentication based on a user identity module for defining a user identification;
an authorization server configured to check information on user's entitlement to services based on the user identification;
a gateway server configured to establish a secured connection, receive a payment message from a service server, forward the payment message to the user, receive a message comprising user's acceptance of a payment transaction, convey the user's acceptance of the payment to the service server, and add the user identification to the secured connection or the message comprising the user's acceptance of a payment transaction; and
a service server configured to secure a payment transaction by using the user identification.

10. The system of claim 9, wherein the authentication server is an authentication protocol subscriber identity module (EAP-SIM) server, the gateway server is a packet data gateway (PDG) or a signaling gateway (SGW), and the authorization server is a remote authentication dial-in user service server.

11. The system of claim 9, further comprising:
a router configured to route service requests to each service server by a proxy server.

12. The system of claim 9, wherein the user identification is stored on a subscriber identity module and the user is operationally coupled to an unsecured network.

13. The system of claim 9, the system further comprising a universal serial bus device in which a subscriber identity module and a payment functionality have been integrated.

14. The system of claim 9, wherein the gateway server is further configured to determine the existence of a subscriber identity module including a payment functionality and to request the user for a credit card number and user identification.

15. The system of claim 9, wherein the gateway server is further configured to verify for a credit server that the user identification is related to the secured connection in question, and to add the user identification to the secured connection or to the message comprising the user's acceptance of a payment transaction, and to convey the message by the gateway server to a credit server for securing a payment transaction.

16. The system of claim 9, wherein the service server is further configured to validate the accepted payment message and forward it to a credit server.

17. An apparatus, comprising a processing unit and a memory including a computer program code, the memory and the computer program code configured to, with the processor, cause the apparatus at least to:
establish a secured connection;
receive a payment message from a service server;
forward the payment message to a user;
receive a message comprising user's acceptance of a payment transaction;
add a predetermined user identification to the secured connection or the message comprising the user's acceptance of a payment transaction; and
convey the user's acceptance of the payment transaction to the service server.

18. The apparatus of claim 17, the apparatus being a packet data gateway (PDG) or a signaling gateway (SGW).

19. The apparatus of claim 17, further configured to determine the existence of a subscriber identity module including a payment functionality and requesting the user for a credit card number and user identification.

20. The apparatus of claim 17, further configured to add the user identification to a response message of the secured connection, the response message being intended to a credit server for securing a payment transaction.

21. The apparatus of claim 17, further configured to verify for a credit server that the user identification is related to the secured connection in question.

22. The apparatus of claim 17, further configured to inform the service server about the verification and the securing of a payment transaction by adding the user identification to a hypertext transfer protocol secure request used to secure the payment transaction.

23. A computer program product, embodied on a computer-readable medium configured to control a processor to perform a method, the method comprising:
carrying out authentication based on a user identity module for defining a user identification by an authentication server and a home location register;
checking information on user's entitlement to services based on the user identification by an authorization server;
if the user is entitled to secured connection services
establishing a secured connection session between a user device and a gateway server by the gateway server;
receiving a payment message from a service server, forwarding the payment message to the user, and receiving a message comprising user's acceptance of a payment transaction by the gateway server;
adding the user identification to the secured connection or the message comprising the user's acceptance of a payment transaction, and conveying the user's acceptance of the payment transaction to the service server by the gateway server; and
securing the payment transaction by using the user identification by the service server or the gateway server.

24. The computer program of claim 23, wherein the authentication server is an extensible authentication protocol subscriber identity module (EAP-SIM) server, the gateway server is a packet data gateway (PDG) or a signaling gateway (SGW) and the authorization server is a remote authentication dial-in user service server.

25. The computer program of claim 23, further comprising:
determining the existence of a subscriber identity module including a payment functionality by the gateway server or a credit server;
requesting the user for a credit card number and user identification.
